(19) United States
(12) Patent Application Publication
(10) Pub. No.: US 2015/0288152 A1
(43) Pub. Date: Oct. 8, 2015

(54) METHODS FOR GRAFFITI ABATEMENT ON PAD-MOUNTED STRUCTURES

(71) Applicant: San Diego Gas & Electric Company, San Diego, CA (US)

(72) Inventors: Allen Hartman, Escondido, CA (US); William Click, San Diego, CA (US)

(21) Appl. No.: 14/677,689

(22) Filed: Apr. 2, 2015

Related U.S. Application Data
(60) Provisional application No. 61/974,263, filed on Apr. 2, 2014.

(51) Int. Cl. H02B 3/00

(52) U.S. Cl. CPC H02B 3/00

(57) ABSTRACT

Methods to reduce the likelihood that a pad-mounted structure will be vandalized by providing a film material that protects the structure against damage from various writing means or chemical means are provided. The film material has properties that make paint and other drawing instruments less penetrating compared to existing coat or surface on the structure. The film material provides an appearance that is less conducive to graffiti, is less desirable of a canvas for graffiti artists, and helps the structure to blend into its surroundings. A method for abating graffiti by applying a film material is also provided.

### TECHNICAL FIELD

The present embodiments relate to graffiti abatement, decorating pad-mounted structures to prevent graffiti, and supplying decorative coatings for pad-mounted structures to prevent graffiti.

### BACKGROUND

A padmount, or pad-mounted transformer, is a ground mounted electric power distribution transformer mounted on a concrete pad. Typically, the transformer is housed in a multi-sided secure structure, such as a locked steel cabinet, to prevent public access to the sensitive and potentially dangerous electrical equipment contained inside. Because pad-mounted transformers are often located in public areas, they are frequent targets for vandals, and keeping these structures free from graffiti can be an onerous and expensive task. Further, the structure containing the transformer is typically not decorated to blend into its surroundings. Thus, pad-mounted transformers frequently stand out visually and make for ideal targets for graffiti. The structures are also displeasing to look at and are therefore sometimes viewed as a nuisance by local residents.

### SUMMARY

The various embodiments of the present methods for graffiti abatement have several features, no single one of which is solely responsible for their desirable attributes. Without limiting the scope of the present embodiments as expressed by the claims that follow, their more prominent features now will be discussed briefly. After considering this discussion, and particularly after reading the section entitled “Detailed Description,” one will understand how the features of the present embodiments provide the advantages described herein.

Aspects of the present disclosure include a method for graffiti abatement. The method in accordance with aspects of the present disclosure can comprise: identifying a multi-sided structure mounted on a stationary pad; sizing the multi-sided structure to obtain at least two dimensions of two adjacent sides including a first side and a second side oriented at a non-zero angle and other than 180 degrees to one another; and applying a first panel to the first side and applying a second panel to the second side; wherein outer surfaces of the first and second panels include graphics that are uninterrupted at an intersection of the first and second panels.

The method wherein the graphics can be selected to visually match surroundings of the multi-sided structure.

The method wherein the multi-sided structure can contain electrical equipment.

The method wherein the electrical equipment can comprise a transformer, a switch gear, a capacitor, a terminator, a fuse, or combinations thereof.

The method can comprise making the first and second panels before the applying step.

The method wherein making the first and second panels can comprise applying the graphics to the first and second panels.

The method wherein the first and second panels can comprise separate pieces.

The method wherein the first and second panels can comprise a unitary sheet.

Aspects of the present disclosure further include a method for making graffiti abatement materials for a multi-sided structure mounted on a stationary pad. The method in accordance with aspects of the present disclosure can comprise: receiving sizing information for the multi-sided structure, including at least two dimensions of two adjacent sides of the multi-sided structure, including a first side and a second side oriented at a non-zero angle and other than 180 degrees to one another; and making a first panel configured to be applied to the first side of the multi-sided structure; and making a second panel configured to be applied to the second side of the multi-sided structure.

The method wherein making the first and second panels can comprise selecting graphics for the first and second panels.

The method wherein making the first and second panels can comprise applying a first portion of the graphics to the first panel and applying a second portion of the graphics to the second panel.

The method wherein the graphics can be selected to visually match surroundings of the multi-sided structure.

The method can further comprise providing the first and second panels to a third party for applying the first and second panels to the multi-sided structure.

The method wherein the first and second panels can comprise separate pieces.

The method wherein the first and second panels can comprise a unitary sheet.

The method wherein the multi-sided structure can contain electrical equipment.

The method wherein the electrical equipment can comprise a transformer, a switch gear, a capacitor, a terminator, a fuse, or combinations thereof.

A yet further aspect of the present disclosure includes a method for making graffiti abatement materials. The method can comprise: identifying a multi-sided structure mounted on a stationary pad; sizing the multi-sided structure to obtain at least two dimensions of two adjacent sides including a first side and a second side oriented at a non-zero angle and other than 180 degrees to one another; making a first panel configured to be applied to the first side of the multi-sided structure; and making a second panel configured to be applied to the second side of the multi-sided structure.

The method wherein making the first and second panels can comprise selecting graphics for the first and second panels.

The method wherein making the first and second panels can comprise applying a first portion of the graphics to the first panel and applying a second portion of the graphics to the second panel.

The method wherein the graphics can be selected to visually match surroundings of the multi-sided structure.

The method can further comprise providing the first and second panels to a third party for applying the first and second panels to the multi-sided structure.

The method wherein the first and second panels can comprise separate pieces.

The method wherein the first and second panels can comprise a unitary sheet.

The method wherein the multi-sided structure can contain electrical equipment.

The method wherein the electrical equipment can comprise a transformer, a switch gear, a capacitor, a terminator, a fuse, or combinations thereof.

### BRIEF DESCRIPTION OF THE DRAWINGS

The various embodiments of the present methods related to graffiti abatement now will be discussed in detail with an emphasis on highlighting the advantageous features. These embodiments depict the novel and non-obvious methods for graffiti abatement shown in the accompanying drawings, which are for illustrative purposes only. These drawings include the following figures, in which like numerals indicate like parts:

FIG. 1 is a front/side perspective view of a multi-sided structure mounted on a stationary pad and defaced by graffiti;

FIG. 2 is a front/side perspective view of a multi-sided structure mounted on a stationary pad and graffiti abatement panels configured for application to the structure, according to the present embodiments; and

FIG. 3 is a front/side perspective view of a multi-sided structure mounted on a stationary pad and having graffiti abatement panels applied to first and second adjacent sides of the structure, according to the present embodiments.

### DETAILED DESCRIPTION

The following detailed description describes the present embodiments with reference to the drawings. In the drawings, reference numbers label elements of the present embodiments. These reference numbers are reproduced below in connection with the discussion of the corresponding drawing features.

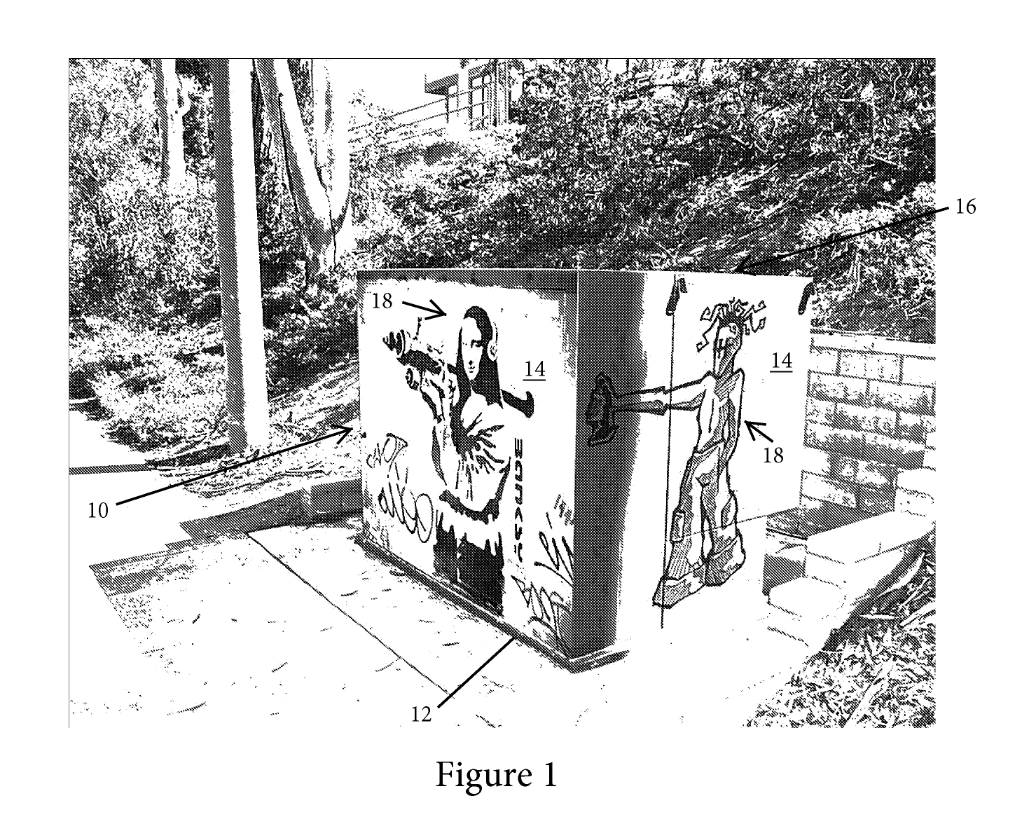

FIG. 1 illustrates a multi-sided structure 10, also sometimes referred to as a utility cabinet, mounted on a stationary pad 12, which may be referred to as a pad-mounted structure or pad mounted utility cabinet 100. The structure 10 includes a plurality of panels 14 defining sides of an enclosure. The enclosure may be closed on all sides, including a top side 16, and may contain an electric power distribution transformer (not shown), or any other type of equipment, such as switches, capacitors, terminators, fuses, and steel poles. The panels 14 of the structure 10 may also be of different shapes along different sides of the structure and when considered as a whole may embody various geometries, including generally rectangular, square, polygonal, and irregular multi-sided shapes. For a typical pad-mounted utility cabinet, the panels 14 are made of steel or another sturdy material. However, the composition of the structure 10 is not germane to the present embodiments, and pad-mounted structures of any type and/or material composition, and having any number of sides, including one or more open sides, may be used in connection with the present embodiments.

As exemplified in FIG. 1, pad-mounted structures 100 can often be defaced by graffiti 18. Among smaller circles, graffiti is considered work of art or street art. For purposes of the present disclosure, any defacing of a pad-mounted structure by someone other than the proprietor or authorized by the proprietor will be grouped under the general category of graffiti. Such graffiti 18 may be removed with various processes, such as sandblasting, and/or painted over in order to maintain the appearance of the structure 10. But graffiti removal and/or covering can be a time consuming and expensive task. Once abated, the structures 10 remain a target for repeated graffiti. It is thus preferable to discourage would be graffiti artists from defacing pad-mounted structures 100 in the first place. The present embodiments provide barrier protection for pad-mounted structures and/or a disincentive for defacing pad-mounted structures, and at the same time provide pad-mounted structures with a more pleasing appearance. For example, it is speculated that when a pad-mounted structure 100 resembles the surrounding or when it is presented as a work of art, the structure 10 is less of a target for graffiti artists since the structure is already considered art or blend in too well to make for an ideal graffiti canvas.

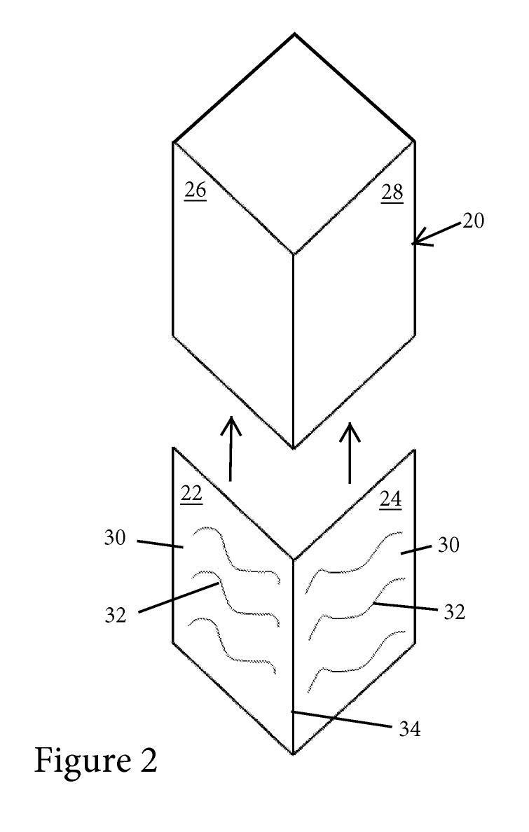

FIG. 2 illustrates, schematically, a pad-mounted multi-sided structure 20 and graffiti abatement panels 22, 24 configured for application to the structure 20, according to the present embodiments. The pad-mounted structure 20 comprises a plurality of sides including at least a first side 26 and a second side 28 that are oriented at a non-zero angle to one another and excluding 180 degrees. As shown, the structure 20 also includes a top side and one or more rear sides. A first one of the abatement panels 22 is sized and shaped for application to the first side 26 of the structure 20 and a second one of the panels 24 is sized and shaped for application to the second side 28 of the structure 20. Each panel 22, 24 may be dimensioned to match the dimensions (height and width) of the side 26, 28 of the structure 20 to which the panel 22, 24 will be applied. Therefore, in various embodiments for making the panels 22, 24, one step may comprise sizing the multi-sided structure 20 to obtain at least two dimensions of two adjacent sides 26, 28, as described in further detail below. In some examples, all of the sides of the structure are measured for use to make a corresponding set of abatement panels. In various other embodiments for making the panels 22, 24, one step may comprise receiving sizing information for the multi-sided structure 20, including at least two dimensions of two adjacent sides 26, 28, as described in further detail below. For example, a manufacturer may receive orders having a number of sizing information for one or more structures to fulfill, such as to make abatement panels for fulfilling the orders. In still other embodiments, each of the sides of the structure 20 may be equipped with a multi-piece panel. For example, the first panel 22 may be formed from two or more smaller pieces that join, such as overlap or placed along a common edge, to form the first panel 22. The first panel 22, which can comprise a single continuous piece or formed from multiple smaller pieces, can then be applied to side 26 of the structure 20.

Each of the panels 22, 24 includes an outer surface 30 that is adorned with graphics 32. The graphics 32 may comprise any type of image, such as a pattern, a design, a drawing, a photograph, etc. In some embodiments, the graphics 32 may be selected to match a backdrop or environment of the structure to which they are applied. For example, if the structure is in a “green” area having surrounding foliage, the graphics 32 on the panels 22, 24 may include depictions of foliage so that the structure visually blends in with its environment. In another example, if the structure is positioned in front of a building, the graphics 32 on the panels 22, 24 may be designed to match the decor of the building, such as matching the building's color. In still another example, the panels may contain artistic graphics 32 of famous movie or TV scenes, of famous architects or landmarks, of man-made apparatuses such as a bus, a house, a phone booth, etc. In general, the graphics 32 may include any number of choices and options.

In some embodiments, the graphics 32 on adjacent panels 22, 24 may form a continuous image that is uninterrupted at the junction 34 of the panels 22, 24. In some examples, the adjacent panels 22, 24 may be separate pieces but the image is continuous across the junction 34. In embodiments for covering structures having more than two sides, a continuous image may be provided that overlaps two or more panels and is uninterrupted at the junction(s) of any of the panels. Optionally, the back side of the structure 20 that is typically not seen by the public may be decorated with a non-continuous or different image or graphic than the panels that are normally visible to the public. The top 16 of the structure 20 may also be adorned with an abatement panel, with or without graphics and may or may not form a continuous graphic with adjacent panels.

In some embodiments, panels configured for application to a multi-sided structure may comprise discrete panels that are not connected to one another. In other embodiments, panels configured for application to contiguous sides of a multi-sided structure may comprise a unitary sheet that is capable of wrapping around corners where contiguous sides of the structure meet. In still further embodiments, a unitary sheet may be configured to wrap around more than two sides of the structure, such as wrapping entirely around the structure. For the continuous sheet, a continuous image that is uninterrupted at one or more junctions 34 is preferred. However, in the continuous sheet embodiment or in embodiments with multiple distinct abatement sheets, the image may have interruptions at the junction(s).

Any or all of the panels in a given embodiment may comprise a thin film material. The film material may be UV resistant, which is advantageous for embodiments configured to cover outdoor structures. Example materials for the film include polyester, vinyl, laminated vinyl, cast vinyl, and adhesive coated pigmented polyvinyl chloride (PVC), such as 3M® CONTROLTAC® Graphic Film. In some embodiments the film material may comprise a clear polyester over-laminating film designed to protect indoor and outdoor markings and decorations against damage from mechanical attack, chemicals, solvents, and/or graffiti 18 paints, such as Avery® SF DOL 6060 Anti-Graffiti 18.

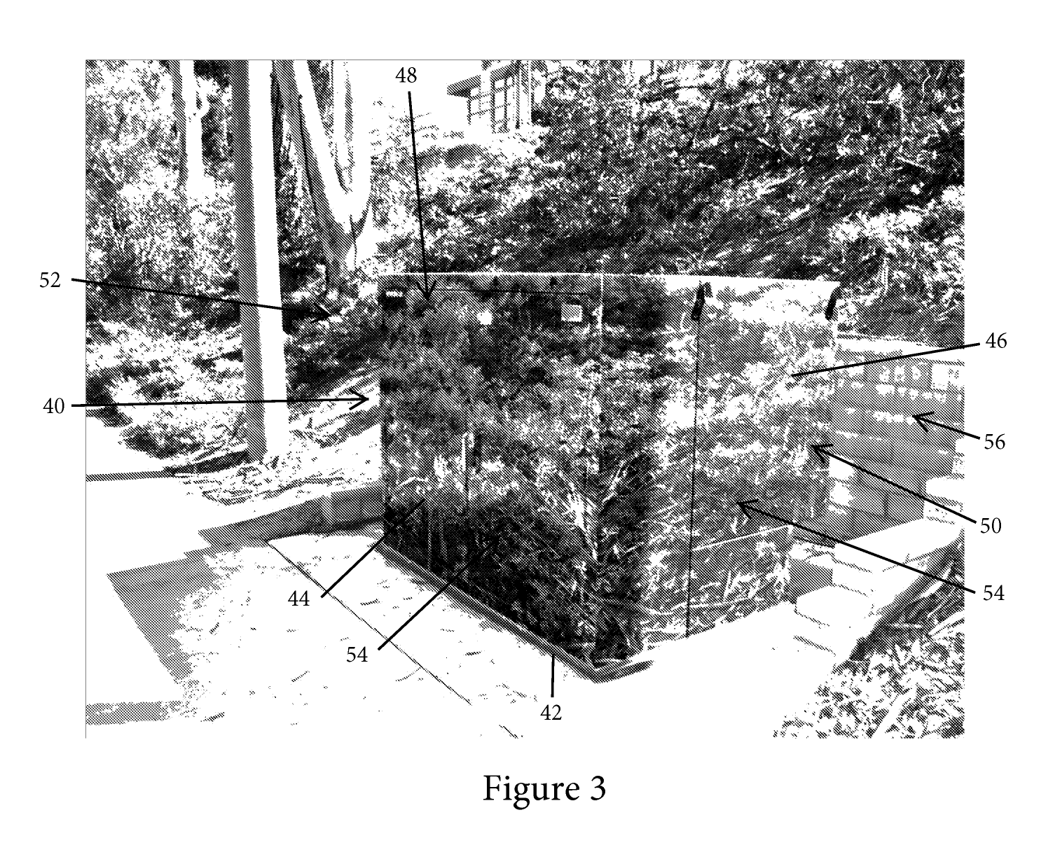

FIG. 3 illustrates a multi-sided structure 40 mounted on a stationary pad 42 and having graffiti abatement panels 44, 46 applied to first and second adjacent sides 48, 50 of the structure 40, according to the present embodiments. Of course, panels may be applied on all sides of the structure, including the top side, to decorate the entire structure 40. Further, in some instances, the backside of the structure that is normally not visible to the public may be left uncovered. The structure 40 sits in front of an embankment 52 on which various plants, trees, shrubs, etc. grow. Graphics 54 on outer surfaces of the panels 44, 46 similarly depict plants, trees, shrubs, etc. to enhance the appearance of the structure 40 and make it less intrusive visually by blending in with the backdrop of the structure 40. The structure 40 also sits in front of a cinderblock wall 56. In an alternative embodiment, therefore, the panels 44, 46 may include graphics depicting a cinderblock wall so that the structure 40 blends seamlessly with its environment. The cinderblock graphics may, in some embodiments, match the color of the actual cinderblock wall 56 to further enhance the ability of the structure 40 to blend in with its environment. In still other examples, the graphics may be fanciful and/or arbitrary, such as based on a RUBIK'S Cube, the name or logo of a local sports team, or a picture of Mount Fuji, to name a few.

The present embodiments include various methods for graffiti abatement, including applying one or more panels bearing graphics to multi-sided pad-mounted structures, reacting to a defaced structure by applying one or more panels bearing graphics to the structure to cover the graffiti, and proactively measuring dimensions of different structures and supplying or ordering panels for applying to the measured structures. Other embodiments include making one or more panels bearing graphics, the panels being configured for application to multi-sided pad-mounted structures for graffiti abatement, either as a proactive program or as a reaction to a defaced structure. In some of these embodiments, the panels may be applied to multi-sided structures by the party making the panels, and in others of these embodiments the panels may be applied to multi-sided structures by third parties.

One example embodiment comprises sizing a multi-sided pad-mounted structure to obtain at least two dimensions of two adjacent sides of the structure, including a first side and a second side, the first and second sides being oriented at a non-zero angle and other than 180 degrees to one another. The process may further comprise applying a first panel including graphics to the first side of the structure and applying a second panel including graphics to the second side of the structure. The graphics on the first and second panels may be uninterrupted at an intersection of the first and second panels. In other examples, the first and second panels may have discrete images that are non-continuous. The first and second panels may comprise discrete pieces or a unitary sheet. The method may further comprise making the panels. Making the panels may comprise applying the graphics to the panels. An additional method in accordance with aspects of the present disclosure is a method for supplying abatement panels that are then used by a third party to abate graffiti on a pad-mounted structure. A yet additional method includes a method for supplying panels that are then used by a third party on a structure as a proactive program to deter graffiti artist.

Another example embodiment comprises making graffiti abatement materials for a multi-sided structure mounted on a stationary pad. The process may comprise receiving sizing information for the multi-sided structure, including at least two dimensions of two adjacent sides of the multi-sided structure, including a first side and a second side oriented at a non-zero angle to one another and other than 180 degrees. The process may further comprise making a first panel configured to be applied to the first side of the multi-sided structure, and making a second panel configured to be applied to the second side of the multi-sided structure. Making the first and second panels may comprise selecting graphics for the first and second panels, and/or applying a first portion of the graphics to the first panel and applying a second portion of the graphics to the second panel. The panels may be applied to the structure, or provided to a third party for applying the panels to the structure. The first and second panels may comprise discrete pieces or a unitary sheet.

Another example embodiment comprises identifying a multi-sided structure mounted on a stationary pad, and sizing the structure to obtain at least two dimensions of two adjacent sides, including a first side and a second side oriented at a non-zero angle to one another. The process may further comprise making a first panel configured to be applied to the first side of the multi-sided structure, and making a second panel configured to be applied to the second side of the multi-sided structure. Making the first and second panels may comprise selecting graphics for the first and second panels, and/or applying a first portion of the graphics to the first panel and applying a second portion of the graphics to the second panel. The panels may be applied to the structure, or provided to a third party for applying the panels to the structure. The first and second panels may comprise discrete pieces or a unitary sheet.

The present embodiments advantageously reduce the likelihood that a pad-mounted structure will be vandalized by providing a film material that protects the structure against damage from mechanical attack, chemicals, solvents, and/or graffiti paints. The film material protects the structure from graffiti by incorporating properties that make paint and other drawing instruments less penetrating compared to the existing coat or surface on the structure, and provides an appearance that is less conducive to graffiti. The wrapped structure becomes a less desirable canvas for graffiti taggers, and increases the visual appeal of the structure, such as by helping the structure to blend into its surroundings.

The above description presents various embodiments of the present invention, and the manner and process of making and using them, in such full, clear, concise, and exact terms as to enable any person skilled in the art to which it pertains to make and use this invention. This invention is, however, susceptible to modifications and alternate constructions from that discussed above that are fully equivalent. Consequently, this invention is not limited to the particular embodiments disclosed. On the contrary, this invention covers all modifications and alternate constructions coming within the spirit and scope of the invention as generally expressed by the following claims, which particularly point out and distinctly claim the subject matter of the invention.

What is claimed is:

1. A method for graffiti abatement, the method comprising:
identifying a multi-sided structure mounted on a stationary pad;
sizing the multi-sided structure to obtain at least two dimensions of two adjacent sides including a first side and a second side oriented at a non-zero angle and other than 180 degrees to one another; and
applying a first panel to the first side and applying a second panel to the second side;
wherein outer surfaces of the first and second panels include graphics that are uninterrupted at an intersection of the first and second panels.

2. The method of claim 1, wherein the graphics are selected to visually match surroundings of the multi-sided structure.

3. The method of claim 1, wherein the multi-sided structure contains electrical equipment.

4. The method of claim 3, wherein the electrical equipment comprises a transformer, a switch gear, a capacitor, a terminator, a fuse, or combinations thereof.

5. The method of claim 1, further comprising making the first and second panels.

6. The method of claim 5, wherein making the first and second panels comprises applying the graphics to the first and second panels.

7. The method of claim 1, wherein the first and second panels comprise separate pieces.

8. The method of claim 1, wherein the first and second panels comprise a unitary sheet.

9. A method for making graffiti abatement materials for a multi-sided structure mounted on a stationary pad, the method comprising:
receiving sizing information for the multi-sided structure, including at least two dimensions of two adjacent sides of the multi-sided structure, including a first side and a second side oriented at a non-zero angle and other than 180 degrees to one another; and
making a first panel configured to be applied to the first side of the multi-sided structure; and
making a second panel configured to be applied to the second side of the multi-sided structure.

10. The method of claim 9, wherein making the first and second panels comprises selecting graphics for the first and second panels.

11. The method of claim 10, wherein making the first and second panels comprises applying a first portion of the graphics to the first panel and applying a second portion of the graphics to the second panel.

12. The method of claim 10, wherein the graphics are selected to visually match surroundings of the multi-sided structure.

13. The method of claim 9, further comprising providing the first and second panels to a third party for applying the first and second panels to the multi-sided structure.

14. The method of claim 9, wherein the first and second panels comprise separate pieces.

15. The method of claim 9, wherein the first and second panels comprise a unitary sheet.

16. The method of claim 9, wherein the multi-sided structure contains electrical equipment.

17. The method of claim 16, wherein the electrical equipment comprises a transformer, a switch gear, a capacitor, a terminator, a fuse, or combinations thereof.

18. A method for making graffiti abatement materials, the method comprising:
identifying a multi-sided structure mounted on a stationary pad;
sizing the multi-sided structure to obtain at least two dimensions of two adjacent sides including a first side and a second side oriented at a non-zero angle and other than 180 degrees to one another;
making a first panel configured to be applied to the first side of the multi-sided structure; and
making a second panel configured to be applied to the second side of the multi-sided structure.

19. The method of claim 18, wherein making the first and second panels comprises selecting graphics for the first and second panels.

20. The method of claim 19, wherein making the first and second panels comprises applying a first portion of the graphics to the first panel and applying a second portion of the graphics to the second panel.

21. The method of claim 19, wherein the graphics are selected to visually match surroundings of the multi-sided structure.

22. The method of claim 18, further comprising providing the first and second panels to a third party for applying the first and second panels to the multi-sided structure.

23. The method of claim 18, wherein the first and second panels comprise separate pieces.

24. The method of claim 18, wherein the first and second panels comprise a unitary sheet.

25. The method of claim 18, wherein the multi-sided structure contains electrical equipment.

26. The method of claim 25, wherein the electrical equipment comprises a transformer.
